(19) United States
(12) Patent Application Publication
(10) Pub. No.: US 2023/0394530 A1
(43) Pub. Date: Dec. 7, 2023

(54) SYSTEMS, METHODS, AND DEVICES FOR VIRTUAL REALITY INTERACTIVE ADVERTISEMENT

(71) Applicant: Meetkai Inc., Marina Del Rey, CA (US)

(72) Inventor: Anthony Sanchez, Marina Del Rey, CA (US)

(21) Appl. No.: 18/205,410

(22) Filed: Jun. 2, 2023

Related U.S. Application Data
(60) Provisional application No. 63/348,159, filed on Jun. 2, 2022.

(51) Int. Cl. G06Q 30/0251; G06T 17/00

(52) U.S. Cl. CPC G06Q 30/0269; G06T 17/00

(57) ABSTRACT

Systems, devices, and methods including: generating a virtual environment where advertisement may be provided to a user of a set of one or more users; determining personalized advertisement for the user of the set of one or more users within the generated virtual environment based on whether a set of publisher preferences are available; determining a 2D/3D interactive advertisement as an experience based on the generated virtual environment and availability of the set of publisher preferences; determining a real time personalization for interactive advertisements based on the determined 2D/3D interactive advertisement as an experience; and determining an interactive advertisement within the virtual environment for each user of the set of one or more users.

### CROSS-REFERENCE TO RELATED APPLICATIONS

This application claims priority to and the benefit of U.S. Provisional Patent Application No. 63/348,159, filed Jun. 2, 2022, the contents of which are hereby incorporated by reference herein for all purposes.

### TECHNICAL FIELD

The present invention relates generally to the field of virtual reality interactive advertisement, specifically, real time personalization for interactive advertisements for a user within a virtual environment where advertisement is being served.

### BACKGROUND

In the field of virtual reality, a set of users may be targeted by advertisers to deliver a personalized experience. This personalized experience or advertising may be a powerful tool that improves advertising relevance for users and increases the return on investment (ROI) for advertisers in a virtual reality environment. In such virtual reality environments, the users may engage with content without any external disruptions or interruptions but also by providing interactive ads, advertising may blend the real world with simulated elements. Therefore, the opportunity of personalization is enhanced further in a virtual environment because the system may place users in a virtual and controlled advertising environment.

### SUMMARY

A method embodiment may include: generating, by a computing device having a processor and addressable memory, a virtual environment where advertisement may be provided to a user of a set of one or more users; determining personalized advertisement for the user of the set of one or more users within the generated virtual environment based on whether a set of publisher preferences may be available from a publisher of an advertisement within the generated virtual environment, where the set of publisher preferences comprise: a set of group unique advertisements, a group singular advertisement, and a non-player character (NPC) advertisement; determining a 2D/3D interactive advertisement as an experience based on the generated virtual environment and availability of the set of publisher preferences, where determining the 2D/3D interactive advertisement as an experience may be based on receiving data from a set of components and executing at least one of: a custom 2D/3D advertisement in group setting component, where the custom 2D/3D advertisement in group setting component may be executed based on receiving data that the publisher has provided group unique advertisements; a custom group 2D/3D advertisement component, where the custom group 2D/3D advertisement component may be executed based on receiving data that the publisher has provided group singular advertisements; and a NPC as an advertisement component, where the NPC as an advertisement component may be executed based on receiving data that the publisher has provided advertisements as NPC; determining a real time personalization for interactive advertisements based on the determined 2D/3D interactive advertisement as an experience, where determining the real time personalization for interactive advertisements may be via executing a real time personalization for interactive advertisements component based on whether a user interacts with an advertisement, where the real time personalization for interactive advertisements component may be configured to continuously check for user interaction data; and determining an interactive advertisement within the virtual environment for each user of the set of one or more users based on the received data from at least one of the components from the set of components.

In additional method embodiments, the method determines the personalized advertisement for the user of a set of one or more users within the generated virtual environment as an initial advertisement offering. In additional method embodiments, the method determines the real time personalization for interactive advertisement after the determination of the personalized advertisement for the user to evolve the interactive advertisement to be more personalized for the user as the user makes interactive choices with the advertisement.

In additional method embodiments, the custom 2D/3D advertisement in group setting component may be configured to select advertisement for different users to show within the virtual environment. In additional method embodiments, the provided group unique advertisements in the custom 2D/3D advertisement in group setting component may be a set of unique advertisements for each user of the set of one more users.

In additional method embodiments, the custom group 2D/3D advertisement component may be configured to select the same advertisement for different users within the virtual environment, based on the aggregation of all user preferences within the virtual environment. In additional method embodiments, the provided group singular advertisements in the custom group 2D/3D advertisement component may be the same advertisements for each user.

In additional method embodiments, the NPC as an advertisement component may be configured to provide advertisements that may be interactive. In additional method embodiments, the user may be able to interact with the advertisements within the virtual environment giving input to the advertisement as it evolves.

In additional method embodiments, real time personalization for interactive advertisements component may be further configured to: determine an initial advertisement state where the user may be shown an interactive advertisement; update the determined initial advertisement state to a next state based on receiving input that the user has taken an advertisement action; and update the advertisement with the received user actions based on whether the updated advertisement state allows new actions.

A computing device embodiment may include a processor and addressable memory, the processor configured to execute a set of components comprising: a custom 2D/3D advertisement in group setting component, where the custom 2D/3D advertisement in group setting component may be executed based on receiving data that a publisher has provided group unique advertisements; a custom group 2D/3D advertisement component, where the custom group 2D/3D advertisement component may be executed based on receiving data that the publisher has provided group singular advertisements; a non-player character (NPC) as an advertisement component, where the NPC as an advertisement component may be executed based on receiving data that the publisher has provided advertisements as NPC; and a real time personalization for interactive advertisements component, where the real time personalization for interactive advertisements component may be executed based on whether a user interacts with an advertisement; where the computing device may be further configured to: generate a virtual environment where advertisement may be provided to a user of a set of one or more users; determine personalized advertisement for the user of the set of one or more users within the generated virtual environment based on whether a set of publisher preferences may be available from the publisher of an advertisement within the generated virtual environment, where the set of publisher preferences comprise: a set of group unique advertisements, a group singular advertisement, and a NPC advertisement; determine a 2D/3D interactive advertisement as an experience based on the generated virtual environment and availability of the set of publisher preferences; determine a real time personalization for interactive advertisements based on the determined 2D/3D interactive advertisement as an experience; and determine an interactive advertisement within the virtual environment for each user of the set of one or more users based on the received data from at least one of the components from the set of components, and where the set of components may be being continuously executed in real-time thereby checking for user interaction data.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a high level functional block diagram of the different components within the interactive advertisement systems, devices, and methods;

FIG. 2 depicts a flow of the different component executions and data transmissions as part of the communication between components for the interactive advertisement embodiments;

FIG. 3 depicts a functional block diagram representing the different components in the virtual reality interactive advertisement to generate a 3D space for a user;

FIG. 4 illustrates an example of a top-level functional block diagram of a computing device embodiment;

FIG. 5 is a high-level block diagram showing a computing system comprising a computer system useful for implementing an embodiment of the system and process;

FIG. 6 shows a block diagram of an example system in which an embodiment may be implemented;

FIG. 7 depicts an illustrative cloud computing environment, according to one embodiment;

FIG. 8 depicts a functional block diagram of a 2D/3D Interactive Advertisement as Experience component;

FIG. 9A depicts a functional block diagram of the Real Time Personalization for Interactive Ads component;

FIG. 9B depicts a flow of the component execution and data transmission of the Real Time Personalization for Interactive Ads component;

FIG. 10 depicts a functional block diagram of the interactive ads experience system where the computing device is configured to provide Custom 2D/3D Ad in group setting (unique ads per user) component;

FIG. 11 depicts a functional block diagram of the interactive ads experience system where the computing device is configured to provide Custom 2D/3D Ad in group setting (same ad) component; and

FIG. 12 depicts a functional block diagram of an alternative advertising type being Non-player character (NPC) as an Advertisement.

### DETAILED DESCRIPTION

The following detailed description describes the present embodiments with reference to the drawings. In the drawings, reference numbers label elements of the present embodiments. These reference numbers are reproduced below in connection with the discussion of the corresponding drawing features. The described technology concerns one or more methods, systems, apparatuses, and mediums storing processor-executable process steps to execute a virtual reality interactive advertisement environment that provides experiences between a virtual world and a physical world.

Virtual reality (VR) describes a computer-generated three-dimensional environment where users interact with objects or other users. In some VR related scenarios, users are placed inside an experience, where during the experience the system stimulates multiple senses, such as vision, hearing, and touch. Virtual reality may be experienced using headsets, which take over the user's vision to simulate the computer-generated three-dimensional environment, replacing the real-world with a virtual one. VR headsets may communicate with the system via a cable or wirelessly and include motion tracking sensors to track user movement, thus enabling a 360-degree world. VR headsets may also connect to smartphones which now provide an even more real-world experience using the smartphone's motion sensors and other built in sensors in conjunction with the VR headset.

Additionally, augmented reality is a subset of virtual reality that simulates artificial objects within the real-world, meaning the virtual objects interact with real-world objects. Using a smartphone camera the system may superimpose additional information on top of the user's real-world environment. This process may also be experienced on a computer screen having the ability to display 3D objects or other such similar devices. Augmented reality may be as immersive as a virtual reality experience given that augmented reality builds an experience based on live surroundings. Augmented reality provides an enhanced version of the real physical world that is achieved through the use of digital visual elements, sound, or other sensory stimuli and often times uses mobile computing power for executing the code. Augmented reality and virtual reality systems execute applications in which users immerse themselves into an alternate reality environment when wearing, for example, a head-mounted display that displays virtual and/or augmented reality user experiences. Accordingly, a computerized method for viewing an augmented reality environment comprises generating a unique environment corresponding to a user and rendering the unique environment on the user device for them to interact with. Such systems and methods utilize broadcasting of information formatted for reception by a user device. The broadcast information is based at least in part on the unique experiences for that user and certain preferences.

Embodiments of the present application disclose a set of components to execute a series of steps to provide direct advertisement (“ad”) or advertisements (“ads”) in the virtual world where the ad is in a virtual space, for example, virtual space for a given point of interest (POI). Accordingly, such interactive advertising experiences communicate with consumers to promote products, brands, services, etc., where in the disclosed embodiments, such experiences are based on physical triggers to initiate them. The interaction is not limited to, for example, a banner ad or a billboard in a virtual space, but also to an object in the virtual space where the object provides an interactive experience by way of using the 3D space to experience the product being advertised. In one embodiment, the physical trigger may be the user's avatar moving up to the object and touching it.

The embodiments surrounding the interactive advertising may be paid and/or unpaid presentation and promotion of products and services by an identified sponsor involving interactions between consumers and products. This interaction may be performed in the 3D virtual space environment through the use of the disclosed system embodiments, where the system is configured to deliver a variety of interactive advertising units as the user interacts with objects displayed within the virtual space. Such advertising may be uniquely placed in the 3D virtual space environment where different users may see different ads on the same billboard due to their user preferences. Additionally, the introduction of objects that provide a transformation of the user from one virtual space to another virtual space related to that object may be implemented by the disclosed systems and processes.

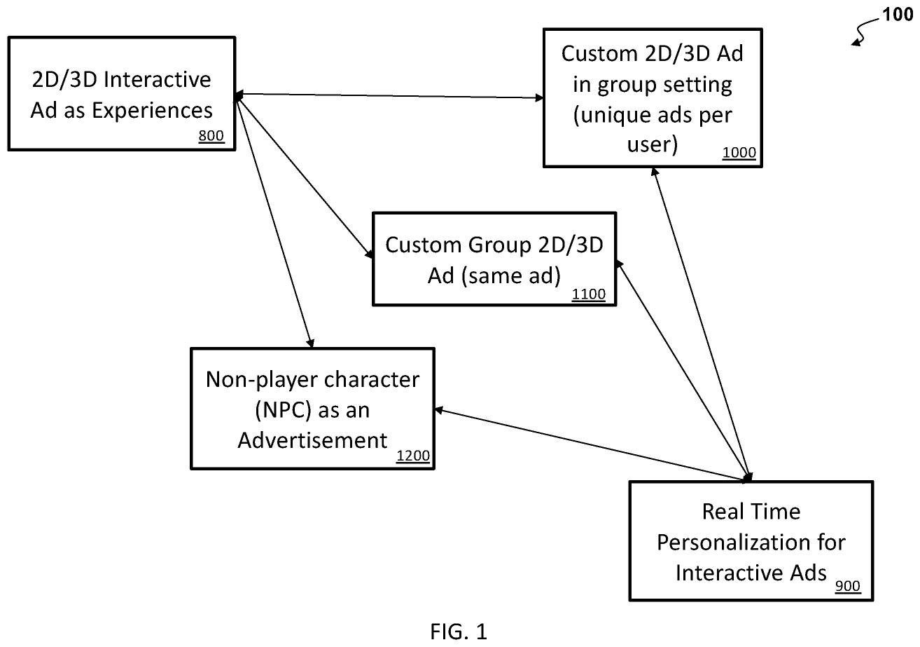

FIG. 1 depicts a high level functional block diagram of the different components within the interactive advertisement within 2D/3D virtual environments, systems, devices, and methods thereof. In some embodiments, the system may initiate by executing a 2D/3D Interactive Ad as Experience component 800 for a given user, where the user is within a virtual environment where advertisement will be served and the 2D/3D Interactive Ad as Experience component 800 may return a selected ad based on a user Id. In one embodiment, depending on the publisher, or advertiser, requirements or settings, the system may utilize at least one of: a Custom 2D/3D Ad in group setting component 1000 (unique ads per user), a Custom Group 2D/3D Ad component 1100 (same ad), and a Non-player character (NPC) as an Advertisement component 1200. In this embodiment, the 2D/3D Interactive Ad as Experiences 800 may be in communication with the aforementioned components to provide a selected Ad based on user specific information and preferences. In another embodiment, a Real Time Personalization for Interactive Ads component 900 may also be in communication with at least one of: the Custom 2D/3D Ad in group setting component 1000 (unique ads per user), the Custom Group 2D/3D Ad component 1100 (same ad), and the Non-player character (NPC) as an Advertisement component 1200. That is, once it is determined what type of advertisement the publisher is offering, e.g., based on personal history, for such existing ads as determined by the 2D/3D Interactive Ad as Experience, a user may be shown an ad that is changing in real time based on the interactions of the user with the virtual environment.

That is, in such embodiments, the Real Time Personalization for Interactive Ads component 900 may be in communication with the Custom 2D/3D Ad in group setting component 1000 (unique ads per user), the Custom Group 2D/3D Ad component 1100 (same ad), and/or Non-player character (NPC) as an Advertisement component 1200 where the Real Time Personalization for Interactive Ads component 900 may be configured to execute and make real time updates to the ad based on current actions taken by the user, in addition to or instead of the personal history. Accordingly, the personalization may be determined for the initial ad offering (for example, in components 800, 1000, 1100, and 1200), while the Real Time Personalization for Interactive Ad component 900 determines advertisement that itself may evolve to be more personalized for the user as they make interactive choices with the ad.

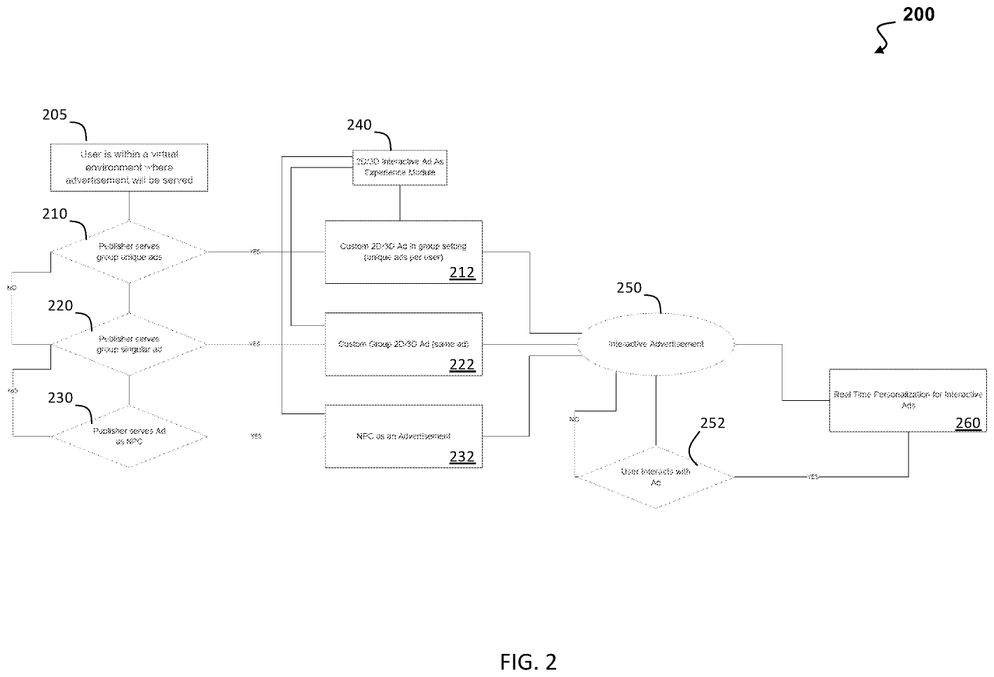

FIG. 2 depicts an example of a data flow of the different component executions and data transmissions as part of the communication between components for the 2D/3D interactive advertisement system 200. According to the disclosed embodiments, the 2D/3D interactive advertisement system may be configured to generate a real time personalization for interactive ads. The virtual environment, as described above, may include a user where the user is within a virtual environment where advertisement will be served 205; the system may then determine the type of ads being provided by publishers, where if the system determines that a publisher serves group unique ads 210 then a Custom 2D/3D Ad in group setting component (unique ads per user) 212 may be executed. If the system determines that the publisher does not serve group unique ads, the system may check to see if the publisher serves group singular ad 220, and if determined to be yes, execute a Custom Group 2D/3D Ad component (same ad) 222; lastly, if the system determines that publisher does not serve group singular ad, then check to determine if the publisher serves ad as NPC 230, and if determined to be yes, execute NPC as an Advertisement component 232. Accordingly, the disclosed system or method may execute the above steps sequentially to determine the publisher preferences, as in, which type of publisher advertisement are desired by the publisher of the advertisement.

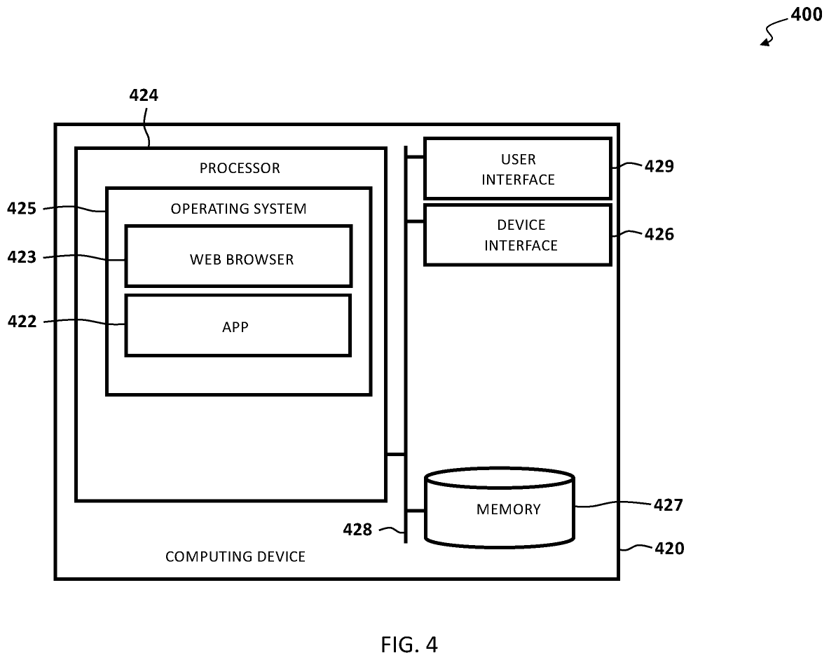

In some embodiments, the custom 2D/3D Ad in group setting component (unique ads per user) 212, the Custom Group 2D/3D Ad component (same ad) 222, and the NPC as an Advertisement component 232, may each be in communication with a 2D/3D Interactive Ad As Experience Component 240 (described in further detail below and in FIG. 4). Upon determination of the type of advertisement, the system may determine an Interactive Advertisement 250, where if the user interactions with the ad 252, the system executes a Real Time Personalization for Interactive Ads component 260. If the user does not interact with the ad 252, then the system may be configured to continuously and in a loop, determine an Interactive Advertisement 250.

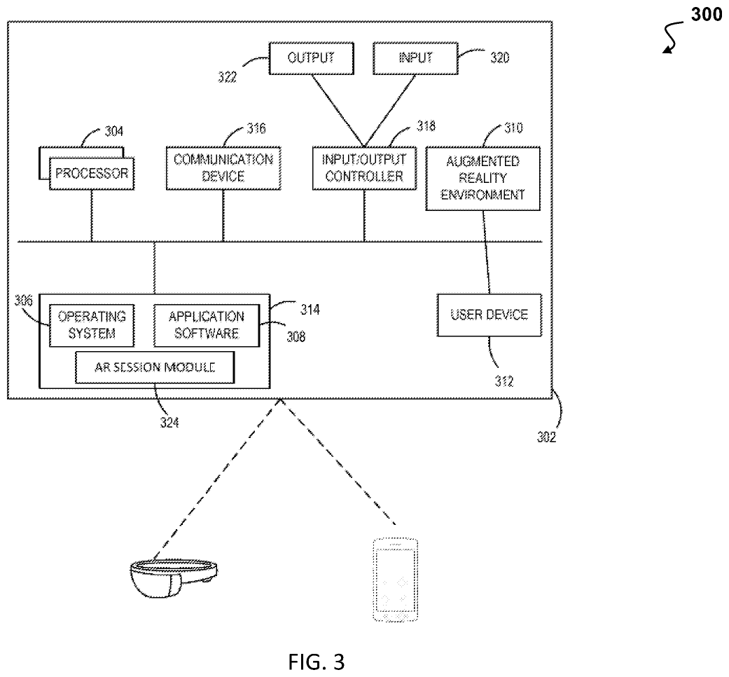

FIG. 3 depicts a functional block diagram representing the different components in the 2D/3D interactive ad as experience for a user system. The disclosed embodiments may be operable with a computing apparatus 302 according to an embodiment as a functional block diagram 300. In one example, components of the computing apparatus 302 may be implemented as a part of an electronic device according to one or more embodiments described in this specification. The computing apparatus 302 may include one or more processors 304 which may be microprocessors, controllers, or any other suitable type of processors for processing computer executable instructions to control the operation of the electronic device, for example, via a communication device 316. Platform software comprising an operating system 306 or any other suitable platform software may be provided on the apparatus 302 to enable application software 308 to be executed on the device. According to an embodiment, viewing of an augmented reality environment 310 from a user device 312 may be executed by software running on a special machine. The computing apparatus 302 may further include an augmented reality (AR) session component 324. It should be noted that the AR session component 324 may be within one or more of the user device 312, such as a VR headset, or other components of the various examples. The AR session component 324 may be configured to perform operations or methods described herein, including, for example, to initialize, authenticate and/or join the user device 312 (e.g., smartphone or tablet) to the VR headset operating as an augmented reality device. An addressable memory 314 may store, among other data, one or more applications or algorithms that include data and executable instructions. The applications, when executed by the processor, operate to perform functionality on the computing device. Exemplary applications include augmented reality applications and/or components, such as the AR session component 324, for example.

In some examples, the computing apparatus 302 detects voice input, user gestures or other user actions and provides a natural user interface (NUI). This user input may be used to author electronic ink, view content, select ink controls, play videos with electronic ink overlays, and for other purposes. The input/output controller 318 outputs data 322 to devices other than a display device in some examples, e.g. a locally connected printing device. NUI technology enables a user to interact with the computing apparatus 302 in a natural manner, free from artificial constraints imposed by input devices 320 such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

The techniques introduced below may be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

FIGS. 1-12 and the following discussion provide a brief, general description of a suitable computing environment in which aspects of the described technology may be implemented. Although not required, aspects of the technology may be described herein in the general context of computer-executable instructions, such as routines executed by a general- or special-purpose data processing device (e.g., a server or client computer). Aspects of the technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer-implemented instructions, data structures, screen displays, and other data related to the technology may be distributed over the Internet or over other networks (including wireless networks) on a propagated signal on a propagation medium (e.g., an electromagnetic wave, a sound wave, etc.) over a period of time. In some implementations, the data may be provided on any analog or digital network (e.g., packet-switched, circuit-switched, or other scheme).

The described technology may also be practiced in distributed computing environments where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Those skilled in the relevant art will recognize that portions of the described technology may reside on a server computer, while corresponding portions may reside on a client computer (e.g., PC, mobile computer, tablet, or smart phone). Data structures and transmission of data particular to aspects of the technology are also encompassed within the scope of the described technology.

FIG. 4 illustrates an example of a top-level functional block diagram of a computing device embodiment 400. The example operating environment is shown as a computing device 420 comprising a processor 424, such as a central processing unit (CPU), addressable memory 427, an external device interface 426, e.g., an optional universal serial bus port and related processing, and/or an Ethernet port and related processing, and an optional user interface 429, e.g., an array of status lights and one or more toggle switches, and/or a display, and/or a keyboard and/or a pointer-mouse system and/or a touch screen. Optionally, the addressable memory may include any type of computer-readable media that can store data accessible by the computing device 420, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network, such as a LAN, WAN, or the Internet. These elements may be in communication with one another via a data bus 428. In some embodiments, via an operating system 425 such as one supporting a web browser 423 and applications 422, the processor 424 may be configured to execute steps of a process establishing a communication channel and processing according to the embodiments described above.

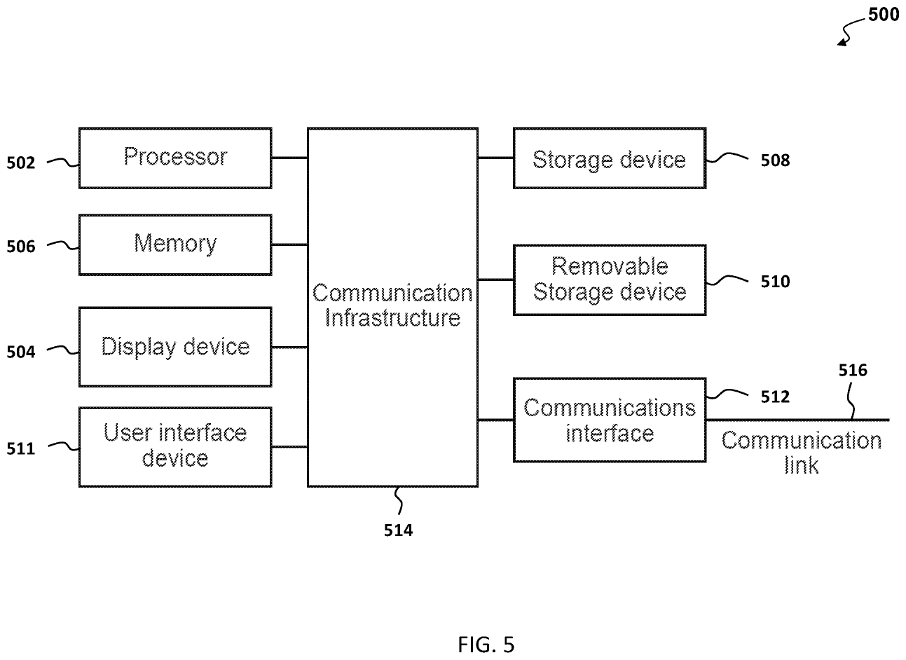

FIG. 5 is a high-level block diagram 500 showing a computing system comprising a computer system useful for implementing an embodiment of the system and process, disclosed herein. Embodiments of the system may be implemented in different computing environments. The computer system includes one or more processors 502, and can further include an electronic display device 504 (e.g., for displaying graphics, text, and other data), a main memory 506 (e.g., random access memory (RAM)), storage device 508, a removable storage device 510 (e.g., removable storage drive, a removable memory module, a magnetic tape drive, an optical disk drive, a computer readable medium having stored therein computer software and/or data), user interface device 511 (e.g., keyboard, touch screen, keypad, pointing device), and a communication interface 512 (e.g., modem, a network interface (such as an Ethernet card), a communications port, or a PCMCIA slot and card). The communication interface 512 allows software and data to be transferred between the computer system and external devices. The system further includes a communications infrastructure 514 (e.g., a communications bus, cross-over bar, or network) to which the aforementioned devices/modules are connected as shown.

Information transferred via communications interface 512 may be in the form of signals such as electronic, electromagnetic, optical, or other signals capable of being received by a communications interface 512, via a communication link 516 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 512. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

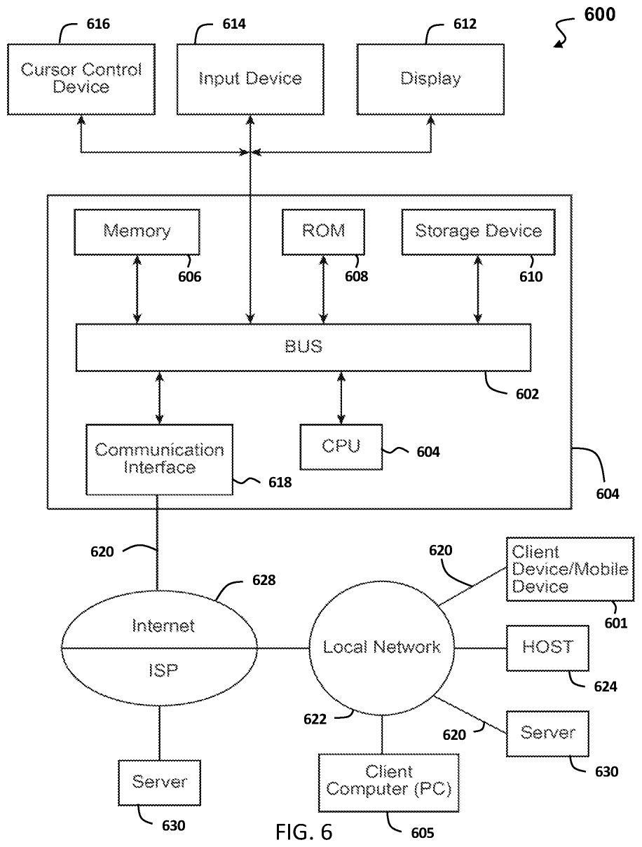

FIG. 6 shows a block diagram of an example system 600 in which an embodiment may be implemented. The system 600 includes one or more client devices 601 such as consumer electronics devices, connected to one or more server computing systems 630. A server 630 includes a bus 602 or other communication mechanism for communicating information, and a processor (CPU) 604 coupled with the bus 602 for processing information. The server 630 also includes a main memory 606, such as a random access memory (RAM) or other dynamic storage device, coupled to the bus 602 for storing information and instructions to be executed by the processor 604. The main memory 606 also may be used for storing temporary variables or other intermediate information during execution or instructions to be executed by the processor 604. The server computer system 630 further includes a read only memory (ROM) 608 or other static storage device coupled to the bus 602 for storing static information and instructions for the processor 604. A storage device 610, such as a magnetic disk or optical disk, is provided and coupled to the bus 602 for storing information and instructions. The bus 602 may contain, for example, thirty-two address lines for addressing video memory or main memory 606. The bus 602 can also include, for example, a 32-bit data bus for transferring data between and among the components, such as the CPU 604, the main memory 606, video memory and the storage 610. Alternatively, multiplex data/address lines may be used instead of separate data and address lines.

The server 630 may be coupled via the bus 602 to a display 612 for displaying information to a computer user. An input device 614, including alphanumeric and other keys, is coupled to the bus 602 for communicating information and command selections to the processor 604. Another type or user input device comprises cursor control 616, such as a mouse, a trackball, or cursor direction keys for communicating direction information and command selections to the processor 604 and for controlling cursor movement on the display 612.

According to one embodiment, the functions are performed by the processor 604 executing one or more sequences of one or more instructions contained in the main memory 606. Such instructions may be read into the main memory 606 from another computer-readable medium, such as the storage device 610. Execution of the sequences of instructions contained in the main memory 606 causes the processor 604 to perform the process steps described herein. One or more processors in a multi-processing arrangement may also be employed to execute the sequences of instructions contained in the main memory 606. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor or multi-core processor to perform the features of the computer system. Accordingly, such computer programs represent controllers of the computer system.

Generally, the term “computer-readable medium” as used herein refers to any medium that participated in providing instructions to the processor 604 for execution. Such a medium may take many forms, including but not limited to, non-volatile media, volatile media, and transmission media. Non-volatile media includes, for example, optical or magnetic disks, such as the storage device 610. Volatile media includes dynamic memory, such as the main memory 606. Transmission media includes coaxial cables, copper wire and fiber optics, including the wires that comprise the bus 602. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 604 for execution. For example, the instructions may initially be carried on a magnetic disk of a remote computer. The remote computer can load the instructions into its dynamic memory and send the instructions over a telephone line using a modem. A modem local to the server 630 can receive the data on the telephone line and use an infrared transmitter to convert the data to an infrared signal. An infrared detector coupled to the bus 602 can receive the data carried in the infrared signal and place the data on the bus 602. The bus 602 carries the data to the main memory 606, from which the processor 604 retrieves and executes the instructions. The instructions received from the main memory 606 may optionally be stored on the storage device 610 either before or after execution by the processor 604.

The server 630 also includes a communication interface 618 coupled to the bus 602. The communication interface 618 provides a two-way data communication coupling to a network link 620 that is connected to the world wide packet data communication network now commonly referred to as the Internet 628. The Internet 628 uses electrical, electromagnetic, or optical signals that carry digital data streams. The signals through the various networks and the signals on the network link 620 and through the communication interface 618, which carry the digital data to and from the server 630, are exemplary forms of carrier waves transporting the information.

In another embodiment of the server 630, the communication interface 618 is connected to a network 622 via a communication link 620. For example, the communication interface 618 may be an integrated services digital network (ISDN) card or a modem to provide a data communication connection to a corresponding type of telephone line, which can comprise part of the network link 620. As another example, the communication interface 618 may be a local area network (LAN) card to provide a data communication connection to a compatible LAN. Wireless links may also be implemented. In any such implementation, the communication interface 618 sends and receives electrical electromagnetic or optical signals that carry digital data streams representing various types of information.

The network link 620 typically provides data communication through one or more networks to other data devices. For example, the network link 620 may provide a connection through the local network 622 to a host computer 624 or to data equipment operated by an Internet Service Provider (ISP). The ISP in turn provides data communication services through the Internet 628. The local network 622 and the Internet 628 both use electrical, electromagnetic or optical signals that carry digital data streams. The signals through the various networks and the signals on the network link 620 and through the communication interface 618, which carry the digital data to and from the server 630, are exemplary forms of carrier waves transporting the information.

The server 630 can send/receive messages and data, including e-mail, and/or program code, through the network, the network link 620 and the communication interface 618. Further, the communication interface 618 can comprise a USB/Tuner and the network link 620 may be an antenna or cable for connecting the server 630 to a cable provider, satellite provider, or other terrestrial transmission system for receiving messages, data, and program code from another source.

The example versions of the embodiments described herein may be implemented as logical operations in a distributed processing system such as the system 600 including the servers 630. The logical operations of the embodiments may be implemented as a sequence of steps executing in the server 630, and as interconnected machine modules within the system 600. The implementation is a matter of choice and can depend on performance of the system 600 implementing the embodiments. As such, the logical operations constituting said example versions of the embodiments are referred to for example, as operations, steps or modules.

Similar to a server 630 described above, a client device 601 can include a processor, memory, storage device, display, input device and communication interface (e.g., e-mail interface) for connecting the client device to the Internet 628, the ISP, or LAN 622, for communication with the servers 630. The system 600 can further include computers (e.g., personal computers, computing nodes) 605 operating in the same manner as client devices 601, where a user can utilize one or more computers 605 to manage data in the server 630.

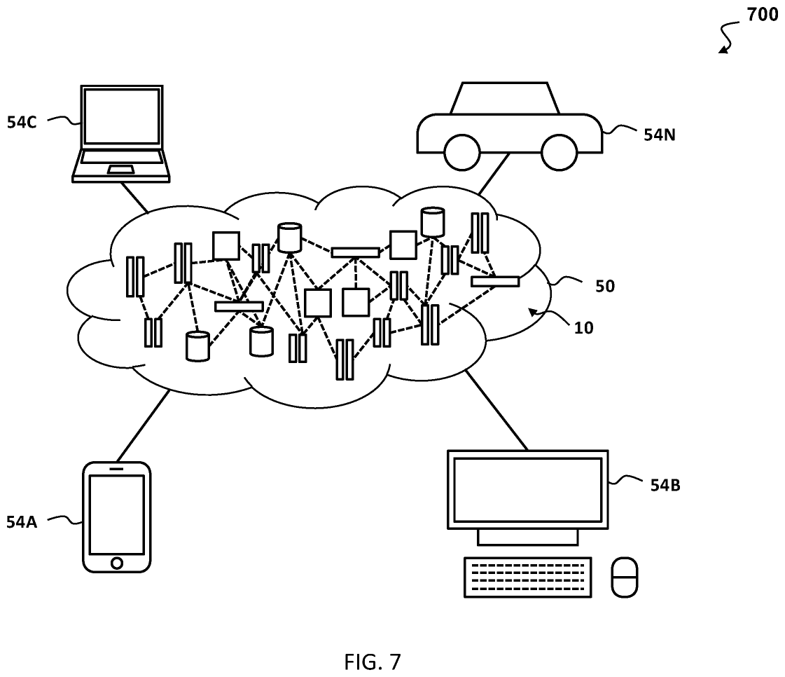

Referring now to FIG. 7, an illustrative cloud computing environment 50 is depicted. As shown, the cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. The nodes 10 may communicate with one another. The nodes may be grouped (not shown) physically or virtually, in one or more networks, such as Private, Community, Public, or Hybrid clouds as described hereinabove, or a combination thereof. This configuration allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

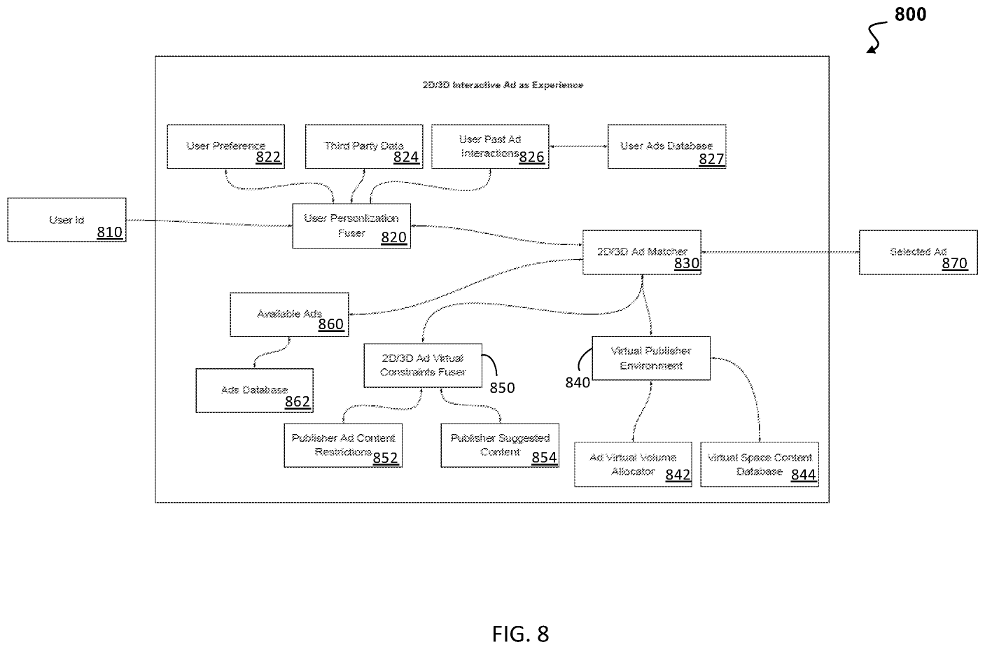

FIG. 8 depicts a functional block diagram of a 2D/3D Interactive Advertisement as Experience component 800 where the computing device is configured to generate a selected Ad 870 based on receiving a user Id 810 and number of other parameters, where the user ID 810 may be a unique identification number associated with the user. That is, the system may be configured to serve Ads that are interactive, from selective choices to full on gameplay. In one example, a user may be able to interact with the ads within a virtual world and provide input to the system as the ad evolves. For instance, a user may walk up to a virtual car, get in the car and be transported to a racing ring where they are competing in the world cup in a specific model car.

In one embodiment, 2D/3D interactive advertisements may be presented as experiences to the user via the system being configured to implement a User Personalization Fuser component 820, where the User Personalization Fuser component 820 may be configured to take user personalization data from preferences and third party data along with past interactions, to aggregate meaningful data about that user, for example, what type of topics a user likes. Accordingly, the User Personalization Fuser component 820 may receive as input a set of User Preferences 822, Third Party Data 824, and data related to User Past Ad Interactions 826, where the User Preferences 822 may include preferences a user has stored as a mapping of defined fields, for example, a user might prefer educational content over gaming content. Additionally, the Third-Party Data 824 may be data from outside of the system, collected from third parties, that may be used to give meaningful personalization information such as likes and dislikes. The embodiments may also include a User Ads Database 827, where the User Past Ad Interactions 826 may be in communication with the User Ads Database 827 and the User Ads Database 827 may be configured to store all user ad interactions history for all users and all available ads. User Past Ad Interactions 826 may be information of previous ads, for example, a user had selected “Red” when prompted for the color of a specific model car interactive advertisement. With all the above info, the disclosed embodiments provide a method for a new advertisement to assume the user likes sport cars and prefers the color red. The representation of this data may be vector representations from a deep learning model or a knowledge graph formed about the user. In one embodiment, the data may be stored within a database or some other representation as known in the technical field.

The disclosed embodiment may further include a 2D/3D Ad Matcher component 830 configured to match users with relevant ads based on at least one of: the 2D/3D virtual information, constraints for a virtual publisher space, and the user profile information (received from the User Personalization Fuser component 820). The 2D/3D Ad Matcher component 830 may be in communication with the User Personalization Fuser component 820 to receive the user profile information, and in addition, with a Virtual Publisher Environment component 840 configured to provide a virtual environment that the ads will be shown in. For example, a virtual room where the ad will be displayed. This is the equivalent to today's ad publishers where a website is the publisher's website and will be served ads to show to users. The Virtual Publisher Environment component 840 may receive input from an Ad Virtual Volume Allocator 842 and a Virtual Space Content Database 844, where the Virtual Publisher Environment component 840 may be configured to collect the volume constraints of an ad that the ad may take up, for example, a 2D/3D interactive ad can take up 5×5×10 volume in the virtual space to display an object. The Virtual Space Content Database 844 may be configured to store all the advertisements with their corresponding content descriptions; for example, a 2D/3D model of a car may have content tags of “luxury car”, “car”, “vehicle” and other features as well to search.

The 2D/3D Ad Matcher component 830 may also be in communication with a 2D/3D Ad Virtual Constraints Fuser component 850 configured to use publisher constraints and suggested content to adjust what ads are being matched. The 2D/3D Ad Virtual Constraints Fuser component 850 may receive as input Publisher Ad Content Restrictions 852 that may include the constraints a publisher may set on a space, for example, the publisher may not want any rated R ads and instead ads that are PG-13. The 2D/3D Ad Virtual Constraints Fuser component 850 may also receive as input Publisher Suggested Content 854 that provides content that the ad publisher may think is relevant and suggest recommending to the users that see the ad.

The 2D/3D Ad Matcher component 830 may further be in communication with an Available Ads component 860 that may be configured to retrieve information about the availability of the ads from an Ads Database 862. Accordingly, the 2D/3D Ad Matcher component 830 may determine and output a selected ad 870 based on the input data received from the User Personalization Fuser component 820, the Virtual Publisher Environment component 840, the 2D/3D Ad Virtual Constraints Fuser component 850, and/or the Available Ads component 860 to create a 2D/3D interactive ad as an experience to the user.

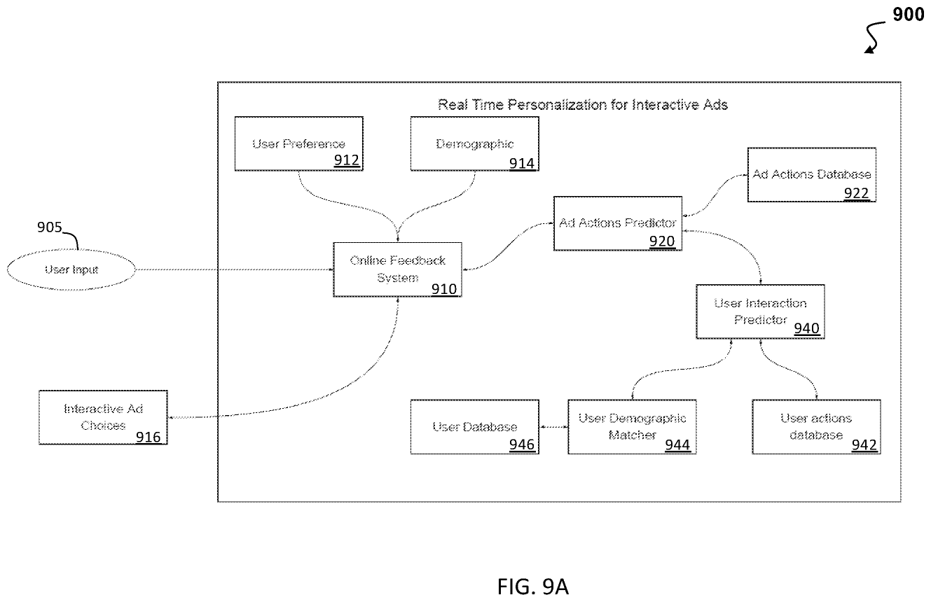

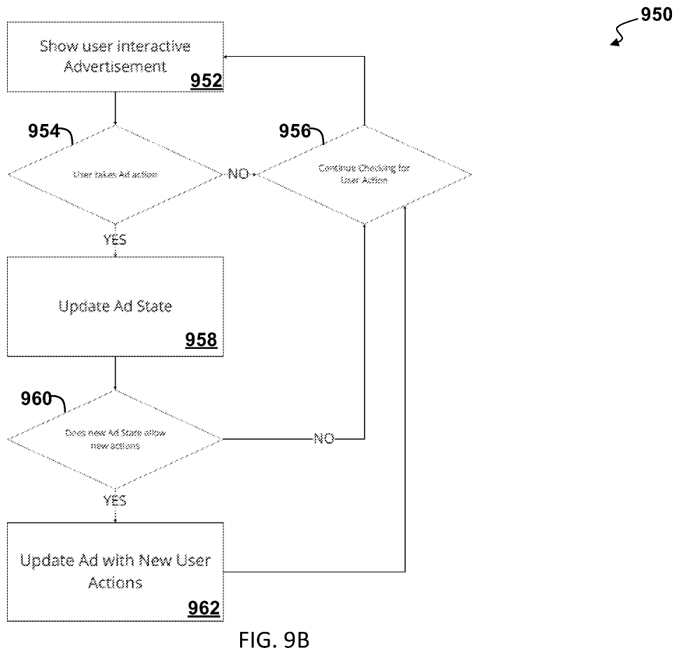

FIG. 9A depicts a functional block diagram of a Real Time Personalization for Interactive Ads component 900 where the computing device is configured to, for existing ads, show/display an ad to a user based on personal history, where using this system a user is shown an advertisement based on personal history but the ad may also be changed as their interactions with the ad develop. That is, when a user interacts with an advertisement, the ad may evolve based on which actions the user had taken. If in one example, the user takes no actions in state 0, then the ad state may be to display a number of items: item 1, item 2, item 3, and item 4, where the possible actions may be to interact with one of the 4 items; upon the interaction of the user with one of the items, for example, item 4, the next state (state n+1), here state 1, may have possible actions that now include an item 5 which is related to item 4. The newly added item 5 may now also have a new possible action or interaction, adding more personalization options. Referring now to FIG. 9A, the component initiates as the Real Time Personalization for Interactive Ads component 900 receives User Input 905, the User Input 905 being input into the interactive ad such as the user choosing to interact with a specific portion of the ad. One example may be where the user is interacting with the necklace in the use case. An Online Feedback System component 910 may be configured to receive input as User Preference 912 and Demographic 914 where this system may be configured to continuously take user input to update the advertisement to increase likelihood of future interactions and ad click-through. The User Preferences 912 may be the preferences a user has stored as a mapping of defined fields where a user may have selected such preferences from predefined options (defined fields) shown to the user such as content rating, interests, etc. For example, a user might prefer educational content over gaming content. Demographic 914 may be the personalization features that a user has in common with a subset of other users.

The Online Feedback System component 910 may be in communication with an Ad Actions Predictor component 920, where the Ad Actions Predictor component 920 may be configured to predict the next action to present to the user, where the next action may be based on: user current interactions, past user interactions, and available actions to choose from. The Ad Actions Predictor component 920 may receive input from an Ad Actions Database 922, the input being available actions that an ad can take to give a user more choices. One example may be the use case where the ability to add a wrist jewelry item is considered an ad action, and that can be taken along with adding a watch or not adding anything at all. The Ad Actions Predictor component 920 may be configured to communicate the predictions to a User Interaction Predictor 940, where the User Interaction Predictor 940 may be configured to take the user's interaction history with other ads and the demographic the user belongs to in order to service the actions predictor. The User Interaction Predictor 940 may communicate with a User actions database 942 that may be configured to store all the user actions with interactive ads, for example, if the user in the past interacted with a clothing advertisement. In addition to the User actions database 942, the User Interaction Predictor 940 may receive input from a User Demographic Matcher 944 that matches a user with a demographic they belong to. This matching may be accomplished by communicating with a User Database 946 that stores the user information along with any groups that have common interaction patterns. One example is a clothing shopper demographic or more specifically, jewelry shopper. Accordingly, the Real Time Personalization for Interactive Ads component 900, using the Online Feedback System component 910 may provide a set of interactive Ad Choices 916 which may be personalized for the user as they make interactive choices with the ad.

FIG. 9B further depicts a flow of the component execution and data transmission of the Real Time Personalization for Interactive Ads component 950. In one embodiment, upon the user interacting with an advertisement in the virtual environment, the advertisement may evolve and be updated based on which actions the user has taken with respect to the advertisement. Accordingly, the advertisement may go through different states where each state may be based on a previous state, for example, a hysteresis effect in the virtual world where there exists a dependence of the state of an advertisement property on its history (the history being an action the user has taken previously amounting to changes in response to the effect causing it). For example, in the above jewelry example, there are two things that are changing with user actions based on a flow described below:

### Staten:

user: no actions taken;
ad state: mannequin with shoes, shirt, pants, and necklace;
possible actions: interact with shoe, interact with shirt, interact with pants, interact with necklace.

### State N+1:

user: interacts with necklace;
ad state: mannequin with shoes, shirt, pants, necklace, and bracelet.
possible actions: interact with shoe, interact with shirt, interact with pants, interact with bracelet

That is, the system may be configured to execute the following method steps: show a user interactive advertisement (step 952); determine if a user takes Ad action by interacting with the shown interactive advertisement (step 954); if no action taken, then the system may continue to check for user action (step 956); and if the user interacts with the advertisement then update the ad state (step 958). This step provides the addition or in some embodiments, subtraction, of possible action an advertisement offers to the user. Therefore, after the ad state has been updated (in step 958), the system may be configured to determine whether a new Ad state allows or leads to new user actions (step 960). In the disclosed embodiments, this determination may be based on the types of actions possible and previous user interaction with the ad amounting to a change in possible actions. If for example, the ad state does not allow for a new user action, then the system may continue checking for user action (step 956 described above). If the system determines that the ad state does allow new user actions, then execute an update to the ad with new user actions (step 962). As to the above example, in this state, the bracelet was added showing the ad has been personalized to someone who likes jewelry more. Additionally, interacting with the bracelet is now a new action the user may take further, adding more personalization options.

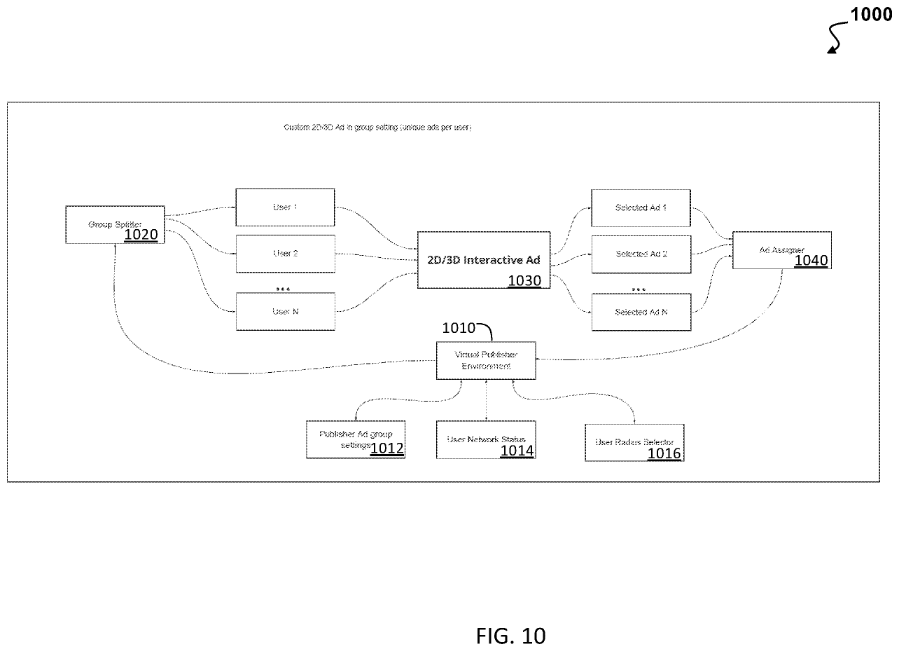

FIG. 10 depicts a functional block diagram of the interactive ads experience component where the component may be configured to provide a personalized Ad via executing a Custom 2D/3D Ad in group setting component 1000 (unique ads per user), where the component selects ads for different users to show within the same space. For example, a group of friends are within a virtual environment, and their user preferences are different than each other, accordingly, the component may be configured to for each user, show different advertisement. Based on this, despite their differences in interest, the users may be shown a relevant advertisement unique to their taste. This component may be configured to include a Virtual Publisher Environment 1010 representing the virtual environment in which the ads will be displayed. In this embodiment, a set of Publisher Ad group Settings 1012 may be communicated to the Virtual Publisher Environment 1010, representing the settings such as restrictions of content not to be shown in the publisher environment, or suggested content. Additionally, a User Network Status 1014 may provide the connection status or speed of the user to the Virtual Publisher Environment 1010, for example, if the user has a connection with low latency, the Virtual Publisher Environment 1010 may be configured to signal to the system that the user computer network and computing device may be able to handle very data heavy interactive ads. A User Radius Selector 1016 may also be providing input to the Virtual Publisher Environment 1010 where the User Radius Selector 1016 selects which users are in the radius (or proximity) to select and which ad to display for them.

In one embodiment, once the Virtual Publisher Environment 1010 is determined, such information may be communicated to a Group Splitter component 1020. The Group Splitter component 1020 may be configured to take the user pool to show the advertisements and split them up into their own users to show ads to. The Group Splitter component 1020 may then output a set of Users 1, 2, . . . N, that provide the relevant user information for the selected user. The component may then transmit the Users 1, 2, . . . N identification and execute the 2D/3D Interactive Ad component 1030 (also see FIG. 8 for detailed discussion) to determine a 2D/3D Interactive Ads as experience. The 2D/3D Interactive Ad component 1030 may then return the Selected Ad 1, 2, . . . N for each user that represents the ad that will be shown for each user. The Custom 2D/3D Ad in group setting 1000 may then output the assigned Ad via an Ad Assigner 1040 which takes the selected ads and assigns which user will see each ad within the publisher environment. For example, User 1 will see Selected Ad 1. The assigned Ads may be provided in a loop back to the Virtual Publisher Environment 1010 for further processing, thereby determining a unique ad per user within the virtual environment.

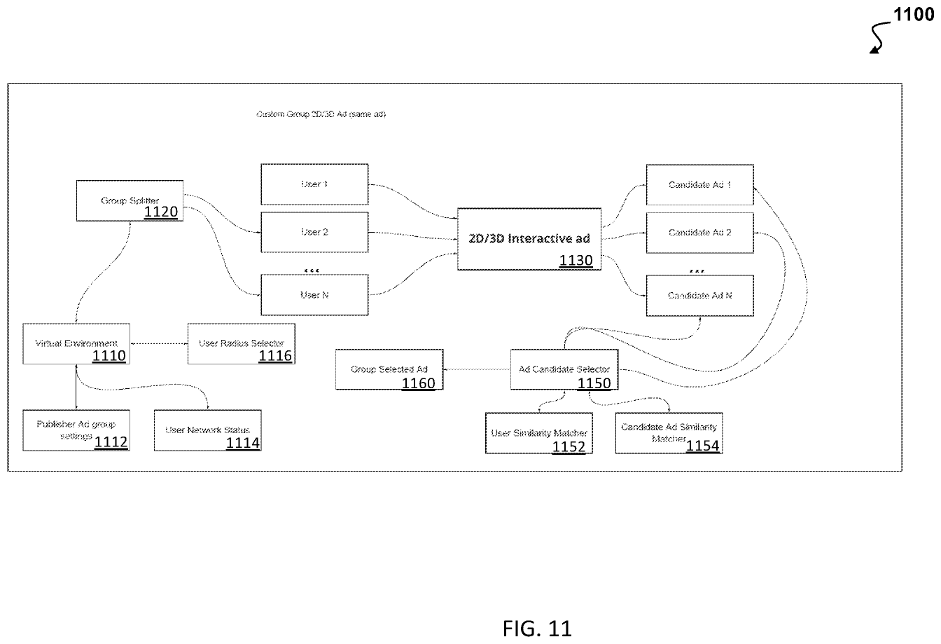

FIG. 11 depicts a functional block diagram of the interactive ads experience system where the computing device is configured to provide a custom group 2D/3D ad via a Custom 2D/3D Ad in group setting component 1100 (same ad), which selects the same ad for different users within the space, taking into account the aggregation of all users within the space. For example, a group of friends are within a virtual environment, and their user preferences are different than each other. Accordingly, despite their differences in interest, the users may be shown a relevant advertisement unique to their taste. The Custom 2D/3D Ad in group setting component 1100 may function in a similar way as the Custom 2D/3D Ad in group setting component 1000 (unique ads per user), where it includes a Virtual Publisher Environment 1110 representing the virtual environment in which the ads will be displayed. In this embodiment, a set of Publisher Ad group Settings 1112 may be communicated to the Virtual Publisher Environment 1110, representing the settings such as restrictions of content not to be shown in the publisher environment, or suggested content. Additionally, a User Network Status 1114 may provide the connection of the user to the Virtual Publisher Environment 1110, for example, the user has a low latency and thereby is able to handle very data heavy interactive ads. A User Radius Selector 1116 may also be providing input to the Virtual Publisher Environment 1110 where the User Radius Selector 1116 selects which users are in the radius (or proximity) to select and which ad to display for them.

In one embodiment, once the Virtual Publisher Environment 1110 is determined, such information may be communicated with a Group Splitter component 1120 where the Group Splitter component 1120 may be configured to take the user pool to show the advertisements and split them up into their own users to show ads to. The Group Splitter component 1120 may then output a set of Users 1, 2, . . . N, that provide the relevant user information for the selected user. The system may then transmit the Users 1, 2, . . . N identification and execute the 2D/3D Interactive Ad component 1130 (also see FIG. 8 for detailed discussion) to determine a 2D/3D Interactive Ads as experience. The 2D/3D Interactive Ad component 1130 may then return a Candidate Ad 1, 2, . . . N for each user that represents the candidate ad for a given user. The Custom 2D/3D Ad in group setting 1100 may then communicate the Candidate Ad with an Ad Candidate Selector component 1150 which may be configured to select from Ad Candidates to choose the best ad for the group as a whole. For example, if there are 3 ads for food and 1 for clothing and all users seem similar to each other, the best ad to choose would be the food ad since it would have the highest likelihood of being selected by the most group members. The Ad Candidate Selector 1150 may determine/select the ad candidate by using information received from a User Similarity Matcher 1152 that is configured to group users into subsets of how similar they are to each other, and a Candidate Ad Similarity Matcher 1154 that is configured to group advertisements into subsets of how similar they are to each other. Based on those two matchers (User Similarity Matcher 1152 and Candidate Ad Similarity Matcher 1154), a Group Selected Ad 1160 may be determined that represents the chosen ad that is most likely to have the highest interaction with the most amount of users within a group.

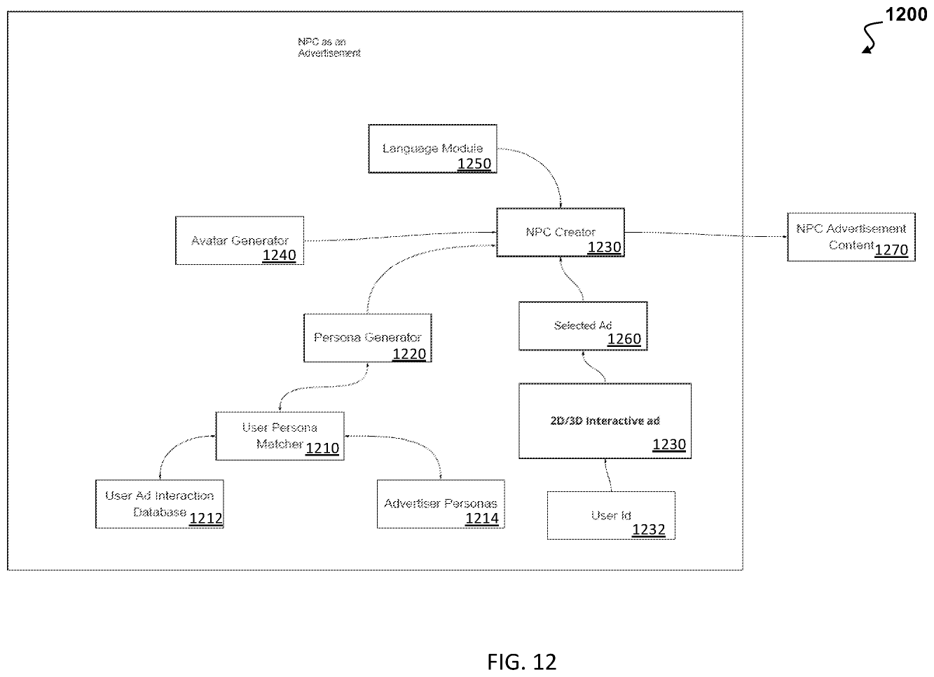

FIG. 12 depicts a functional block diagram of an alternative advertising type being Non-player character (NPC) as an Advertisement component 1200. This component may be configured to serve ads that are interactive, from selective choices to full on gameplay, where a user is able to interact with the ads within a virtual world giving input to the ad as it evolves. For example, a user can walk up to a virtual car, get in the car and be transported to a racing ring where they are competing in the world cup in a specific car model. The system may use a User Persona Matcher 1210 configured to match a user with a persona that they have in the past enjoyed interacting with. This matching may be done via data from a User Ad Interaction Database 1212 which stores all interactions of a user with different persona ads and an Advertiser Personas 1214 which provides different personas that can embody an advertisement. For example, this can be a soft spoken personality or a pushy salesperson.

Embodiments also include a Persona Generator 1220 configured to generate a Persona by taking into account the best matched person from the User Persona Matcher 1210. The Persona Generator 1220 may then provide input to an NPC Creator 1230, where the NPC Creator 1230 may be configured to take all aspects of the NPC communication, personality, and virtual embodiment to create the full NPC. Referring now to an Avatar Generator 1240, the system may use the Avatar Generator 1240 to generate the 2D/3D Model for the avatar of the persona. For example, if the person generated is a pushy salesperson, this avatar can have a suit and tie on. The NPC Creator 1230 may also receive input from a Language Module 1250 that provides a language model that will allow the person to communicate via text or speech audio.

In one embodiment, a User ID 1232 which is a unique identification number of the user may be provided to a 2D/3D Interactive Ad 1230 (also see FIG. 8 for detailed discussion) that may then provide as output a Selected Ad 1260 which signifies the ad that will be shown to the user. Accordingly, the NPC Creator 1230, may determine an NPC Advertisement Content 1270 based on: a received selected Ad, a generated Persona, a generated Avatar, and language model. The NPC Creator 1230 may be configured to use the selected ad with the created NPC to convey the NPC Advertisement content 1270. For example, a pushy salesperson that is selling cars.

In the above disclosed embodiments, the user device may be any type of display system providing a view through optics so that the generated image that is being displayed to the user is overlaid onto a real-world view. Thus, as a wearable display system, an augmented reality device can incorporate components, such as processing unit(s), computer interface(s) that provide network connectivity, and camera(s) etc. These components can be housed in the headset or in a separate housing connected to the headset by wireless or wired means. The user device may also include an imaging application implemented to generate holograms for display. The imaging application may be implemented as a software application or components, such as computer-executable software instructions that are executable with the processing system. The imaging application may be stored on computer-readable storage memory (e.g., the memory), such as any suitable memory device or electronic data storage implemented in the alternate reality device.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above. The present embodiments are, therefore, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

What is claimed is:

1. A method comprising:
generating, by a computing device having a processor and addressable memory, a virtual environment where advertisement is provided to a user of a set of one or more users;
determining personalized advertisement for the user of the set of one or more users within the generated virtual environment based on whether a set of publisher preferences are available from a publisher of an advertisement within the generated virtual environment, wherein the set of publisher preferences comprise: a set of group unique advertisements, a group singular advertisement, and a non-player character (NPC) advertisement;
determining a 2D/3D interactive advertisement as an experience based on the generated virtual environment and availability of the set of publisher preferences, wherein determining the 2D/3D interactive advertisement as an experience is based on receiving data from a set of components and executing at least one of:
a custom 2D/3D advertisement in group setting component, wherein the custom 2D/3D advertisement in group setting component is executed based on receiving data that the publisher has provided group unique advertisements;
a custom group 2D/3D advertisement component, wherein the custom group 2D/3D advertisement component is executed based on receiving data that the publisher has provided group singular advertisements; and
a NPC as an advertisement component, wherein the NPC as an advertisement component is executed based on receiving data that the publisher has provided advertisements as NPC;
determining a real time personalization for interactive advertisements based on the determined 2D/3D interactive advertisement as an experience, wherein determining the real time personalization for interactive advertisements is via executing a real time personalization for interactive advertisements component based on whether a user interacts with an advertisement, wherein the real time personalization for interactive advertisements component is configured to continuously check for user interaction data; and
determining an interactive advertisement within the virtual environment for each user of the set of one or more users based on the received data from at least one of the components from the set of components.

2. The method of claim 1, wherein the method determines the personalized advertisement for the user of a set of one or more users within the generated virtual environment as an initial advertisement offering.

3. The method of claim 2, wherein the method determines the real time personalization for interactive advertisement after the determination of the personalized advertisement for the user to evolve the interactive advertisement to be more personalized for the user as the user makes interactive choices with the advertisement.

4. The method of claim 1, wherein the custom 2D/3D advertisement in group setting component is configured to select advertisement for different users to show within the virtual environment.

5. The method of claim 4, wherein the provided group unique advertisements in the custom 2D/3D advertisement in group setting component is a set of unique advertisements for each user of the set of one more users.

6. The method of claim 1, wherein the custom group 2D/3D advertisement component is configured to select the same advertisement for different users within the virtual environment, based on the aggregation of all user preferences within the virtual environment.

7. The method of claim 6, wherein the provided group singular advertisements in the custom group 2D/3D advertisement component is the same advertisements for each user.

8. The method of claim 1, wherein the NPC as an advertisement component is configured to provide advertisements that are interactive.

9. The method of claim 8, wherein the user is able to interact with the advertisements within the virtual environment giving input to the advertisement as it evolves.

10. The method of claim 1, wherein real time personalization for interactive advertisements component is further configured to:
determine an initial advertisement state where the user is shown an interactive advertisement;
update the determined initial advertisement state to a next state based on receiving input that the user has taken an advertisement action; and
update the advertisement with the received user actions based on whether the updated advertisement state allows new actions.

11. A computing device having a processor and addressable memory, the processor configured to execute a set of components comprising:
a custom 2D/3D advertisement in group setting component, wherein the custom 2D/3D advertisement in group setting component is executed based on receiving data that a publisher has provided group unique advertisements;
a custom group 2D/3D advertisement component, wherein the custom group 2D/3D advertisement component is executed based on receiving data that the publisher has provided group singular advertisements;
a non-player character (NPC) as an advertisement component, wherein the NPC as an advertisement component is executed based on receiving data that the publisher has provided advertisements as NPC; and
a real time personalization for interactive advertisements component, wherein the real time personalization for interactive advertisements component is executed based on whether a user interacts with an advertisement;
wherein the computing device is further configured to:
generate a virtual environment where advertisement is provided to a user of a set of one or more users;
determine personalized advertisement for the user of the set of one or more users within the generated virtual environment based on whether a set of publisher preferences are available from the publisher of an advertisement within the generated virtual environment, wherein the set of publisher preferences comprise: a set of group unique advertisements, a group singular advertisement, and a NPC advertisement;
determine a 2D/3D interactive advertisement as an experience based on the generated virtual environment and availability of the set of publisher preferences;
determine a real time personalization for interactive advertisements based on the determined 2D/3D interactive advertisement as an experience; and
determine an interactive advertisement within the virtual environment for each user of the set of one or more users based on the received data from at least one of the components from the set of components, and wherein the set of components are being continuously executed in real-time thereby checking for user interaction data.
